(19) United States
(12) Patent Application Publication
(10) Pub. No.: US 2022/0188749 A1
(43) Pub. Date: Jun. 16, 2022

(54) SMART LOGISTICS LABEL SYSTEM AND METHOD OF USING THE SAME

(71) Applicant: NETRONIX, INC., Jubei City (TW)

(72) Inventors: PEI SHUO HUANG, JUBEI CITY (TW); LIAO HSIUNG LAI, JUBEI CITY (TW)

(21) Appl. No.: 17/179,910

(22) Filed: Feb. 19, 2021

(30) Foreign Application Priority Data
Dec. 11, 2020 (TW) 109143753

(51) Int. Cl. G06Q 10/08; B65C 9/46; G06K 19/06

(52) U.S. Cl. CPC G06Q 10/087; B65C 2009/0003; G06K 19/06028; B65C 9/46

(57) ABSTRACT

A smart logistics label system comprises a control device and a logistics label device. The control device acquires identity label information from the logistics label device and stores it as identity comparison label information. When goods information input into the control device matches the identity label information, the control device generates a goods label pattern according to the goods information.

The control device asks the logistics label device to provide identity label information again; compares whether it matches the identity comparison label information; and if yes, transmits the goods label pattern to the logistics label device for presentation. Then, the goods label pattern is input into the control device for verifying the correctness of the goods label pattern. The present invention perform double verifications to guarantee that the goods label pattern is presented on the corresponding electronic label, whereby to raise the accuracy of allocating goods.

This application claims priority of Application No. 109143753 filed in Taiwan on 11 Dec. 2020 under 35 U.S.C. § 119; the entire contents of all of which are hereby incorporated by reference.

### BACKGROUND OF THE INVENTION

### Field of the Invention

The present invention relates to a data processing system or method, particularly to a smart logistics label system and a method of using the same.

### Description of the Prior Art

With fast development of online shopping and convenience stores, the manufacturers or service providers are diversifying the packaging design. Thus, the logistics industries deal with more and more businesses and experience more and more difficulties in delivering products now. Massive logistics affairs make the related procedures more and more troublesome and laborious. The conventional transportation technology has been unable to handle the business of delivering an astronomical number of goods.

At present, the logistics industry classifies the goods and distributes different types of goods to different logistics boxes. With fast increasing number of goods, the logistics boxes are still unable to completely solve the problem, however. Thus, the storage and logistics industries have suffered many problems so far. Each logistics personnel has to handle a great number of logistics boxes. It is hard to achieve effective categorization and recording in logistics activities merely by logistics personnel's manually recording the destinations of logistics boxes and information of goods. At present, no appropriate mechanism is used to assist logistics personnel in verifying the goods inside a logistics box. Once the goods is placed into a wrong logistics box, the goods will be sent to a wrong destination, which not only degrades the efficiency of warehousing and logistics but also wastes many resources.

Accordingly, the present invention proposes a smart logistics label system and a method of using the same to overcome the abovementioned problems. The present invention can effectively assist logistics personnel in allocating goods, improve the warehousing and delivering problems, and increase the logistics efficiency.

### SUMMARY OF THE INVENTION

The primary objective of the present invention is to provide a smart logistics label system and a method of using the same, which can perform double verifications to check whether the goods label pattern is presented on the corresponding electronic label, whereby to raise the accuracy of allocating goods to logistics boxes, decrease errors of logistics operations, and promote the logistics efficiency.

Another objective of the present invention is to provide a smart logistics label system and a method of using the same, which can entirely electronically control logistics systems, increase the efficiency of logistics systems and decease the cost of logistics operations.

In order to achieve the abovementioned objectives, the present invention proposes a smart logistics label system, which is applicable to a plurality of logistics boxes, and which comprises at least one logistics label device and a control device. The logistics label device is installed on a logistics box, including an electronic label and a display. Identity label information is stored in the electronic label. The control device is in signal communication with the logistics label device. The control device includes a transceiver unit, a database, a processing unit and an input unit. The transceiver unit may send out an identity request signal to the electronic device. The electronic label transmits the identity label information to the transceiver unit. The database has a goods identity corresponding table. The processing unit is connected with the transceiver unit and the database. The processing unit receives the identity label information and stores the identity label information as identity comparison label information. The input unit is connected with the processing unit and inputs goods information to the processing unit. The processing unit accesses the goods identity corresponding table in the database to compare the goods information with the corresponding identity label information and generate a goods label pattern and store the goods label pattern in the database to function as a goods comparison label pattern. The processing unit receives the identity label information through the transceiver unit once again. If the identity label information matches the identity comparison label information, the processing unit controls the transceiver unit to transmit the goods label pattern to the display unit for presentation. The input unit scans the goods label pattern on the display unit and transmits the goods label pattern to the processing unit. If the processing unit determines that the goods label pattern matches the goods comparison label pattern, the processing unit generates a confirmation signal.

In one embodiment, the control device further comprises a display unit, which is connected with the processing unit for displaying the confirmation signal. If the processing unit determines that the goods label pattern does not match the goods comparison label pattern, the processing unit generates an alarm signal to the display unit, and the display unit generates an alert according to the alarm signal.

In one embodiment, the input unit is a camera.

In one embodiment, the goods identity corresponding table includes a plurality of pieces of goods information and a plurality of pieces of identity label information.

In one embodiment, the electronic label is a Radio Frequency Identification (RFID) electronic label.

In one embodiment, the display unit is an electronic paper.

In one embodiment, the transceiver unit is a Near-Field Communication (NFC) transceiver unit.

In one embodiment, the processing unit may send out a picture-elimination signal to the display unit of the logistics label device.

The present invention also proposes a method of using a smart logistics label system, which comprises steps: a control device sending out an identity request signal to a logistics label device to make the logistics label device transmit identity label information to the control device, and the control device storing the identity label information as identity comparison label information; inputting goods information to the control device; if the control device determines that the goods information matches the identity label information, the control device generating a goods label pattern according to the goods information and storing the goods label pattern as a goods comparison label pattern; the control device sending out an identity request signal to the logistics label device once again to make the logistics label device transmit the identity label information to the control device; if the control device determines that the identity label information matches the identity comparison label information, the control device transmitting the goods label pattern to the logistics label device to make the logistics label device display the goods label pattern; inputting the goods label pattern to the control device, and the control device determining whether the goods label pattern matches the goods comparison label pattern; if the goods label pattern matches the goods comparison label pattern, the control device generating a conformation-reminding signal; if the goods label pattern does not match the goods comparison label pattern, the control device generating an alarm signal.

In one embodiment, after the control device sends out the identity request signal to the logistics label device and the logistics label device transmits the identity label information to the control device for storage, the control device sends out a picture-elimination signal to the logistics label device to eliminate the picture on the display of the logistics label device.

In one embodiment, in the step of determining whether the goods information is corresponding to the identity label information, the control device determines whether the goods information is corresponding to the identity label information according to a goods identity corresponding table, wherein the goods identity corresponding table includes a plurality of pieces of goods information and a plurality of pieces of corresponding identity label information.

Below, embodiments are described in detail to make easily understood the objectives, technical contents, characteristics, and accomplishments of the present invention.

### BRIEF DESCRIPTION OF THE DRAWINGS

FIG. 1 is a diagram schematically showing an application of a smart logistics label system according to one embodiment of the system of the present invention.

FIG. 2 is a block diagram of a smart logistics label system according to one embodiment of the system of the present invention.

FIG. 3 is a flowchart of a method of using a smart logistics label system according to one embodiment of the present invention.

### DETAILED DESCRIPTION OF THE INVENTION

The present invention can perform double verifications of whether the goods label pattern presented on the electronic label is correctly displayed on the corresponding electronic label, whereby to raise the accuracy of allocating goods to logistics boxes, significantly decrease the errors of logistics operations, lower the cost of logistics management, entirely electronically control the logistics system, and promote the logistics efficiency.

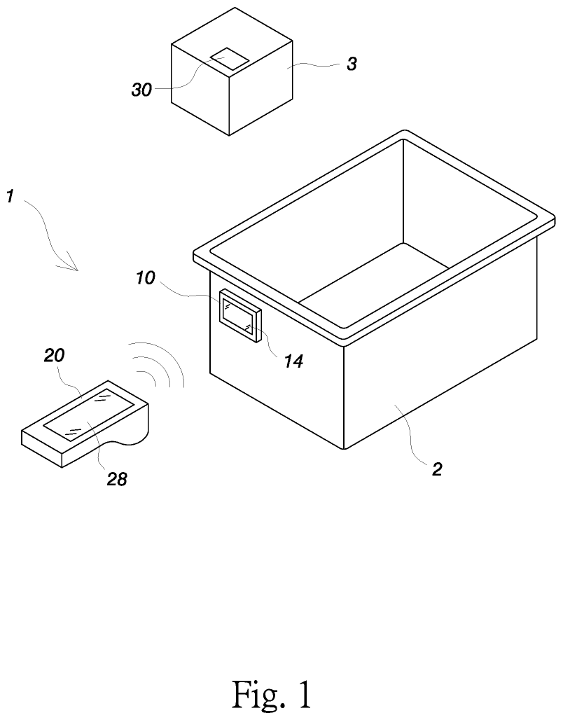

Below, the smart logistics label system and the method of using the same of the present invention are described in detail to demonstrate how the present invention achieve its efficacies. Refer to FIG. 1 for the architecture of the smart logistics label system 1 of the present invention. The smart logistics label system 1 is applied to a plurality of logistics boxes 2 and comprises at least one logistics label device 10 and a control device 20. In one embodiment, the present invention comprises a plurality of logistics label devices 10. The logistics label devices 10 are respectively installed in different logistics boxes 2. Therefore, each logistics box 2 has a corresponding logistics label device 10. Thus, the logistics personnel can recognize the identity of each logistics box 2 through the corresponding logistics label device 10. The control device 20 may be a handheld device. The control device 20 can detect the information of the logistics label device 10 and goods 3 and provides the information to logistics personnel for data processing.

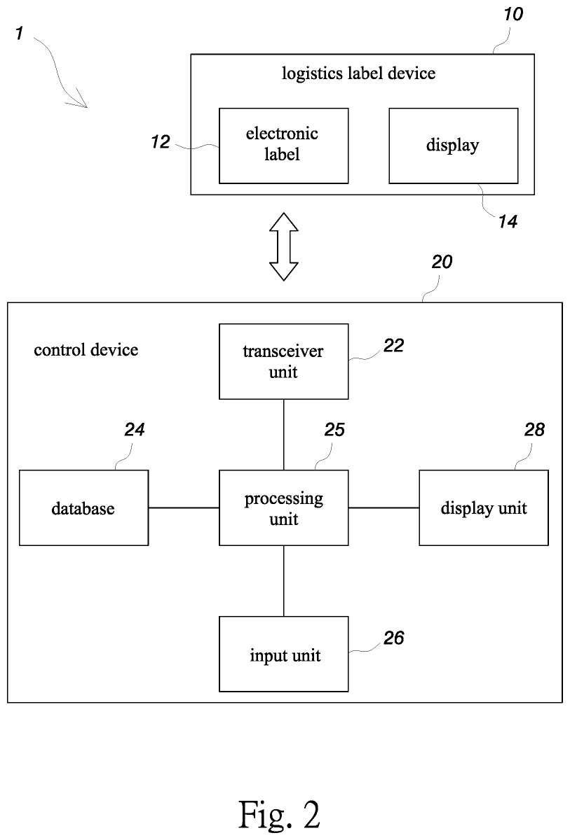

Refer to FIG. 1 and FIG. 2 for the architecture of the logistics label device 10 and the control device 20. Firstly is described the logistics label device 10. Each logistics label device 10 includes an electronic label 12 and a display 14. In one embodiment, the electronic label 12 is a Radio Frequency Identification (RFID) electronic label. The electronic label 12 has identity label information. In one embodiment, the display 14 is an electronic paper. In one embodiment, the electronic paper does not need batteries. The electronic paper can change the presented image merely according to the external energetic signal received by the electronic paper. Refer to FIG. 1 and FIG. 2 again. The control device 20 is in signal communication with the logistics label device 10. In one embodiment, the control device 20 includes a transceiver unit 22, a database 24, a processing unit 25, an input unit 26 and a display unit 28. The transceiver unit 22, the database 24, the input unit 26 and the display unit 28 are all in signal communication with the processing unit 25.

In one embodiment, the transceiver unit 22 is a Near-Field Communication (NFC) transceiver unit. The transceiver unit 22 may send out an NFC signal carrying an identity request signal to the electronic label 12 of the logistics label device 10 to request the electronic label 12 to transmit identity label information to the transceiver unit 22. The database 24 may be a storage device for storing data, such as a hard drive. In one embodiment, the database 24 has a goods identity corresponding table. The goods identity corresponding table includes a plurality of pieces of goods information and a plurality of pieces of corresponding identity label information. The goods information is obtained via scanning a goods bar code 30 attached to a goods 3. The goods information includes the description of the goods 3, the transportation time point, the destination, etc. In general, what goods 3 is to be placed in a given logistics box 2 is determined before the logistics personnel allocates goods 3 to logistics boxes 2. The goods identity corresponding table is thus drafted. In other words, a goods 3 should be placed in a corresponding logistics box 2, and the logistics label device 10 of each logistics box 2 has corresponding identity label information. Therefore, each piece of goods information is corresponding to a specified piece of identity label information.

The processing unit 25 is a Central Processing Unit (CPU), controlling the activities of the transceiver unit 22, the database 24, the input unit 26 and the display unit 28. The input unit 26 is a camera, providing the captured information for the processing unit 25. The display unit 28 may be a screen, presenting the information generated by the processing unit 25 to remind the logistics personnel of the current logistics information.

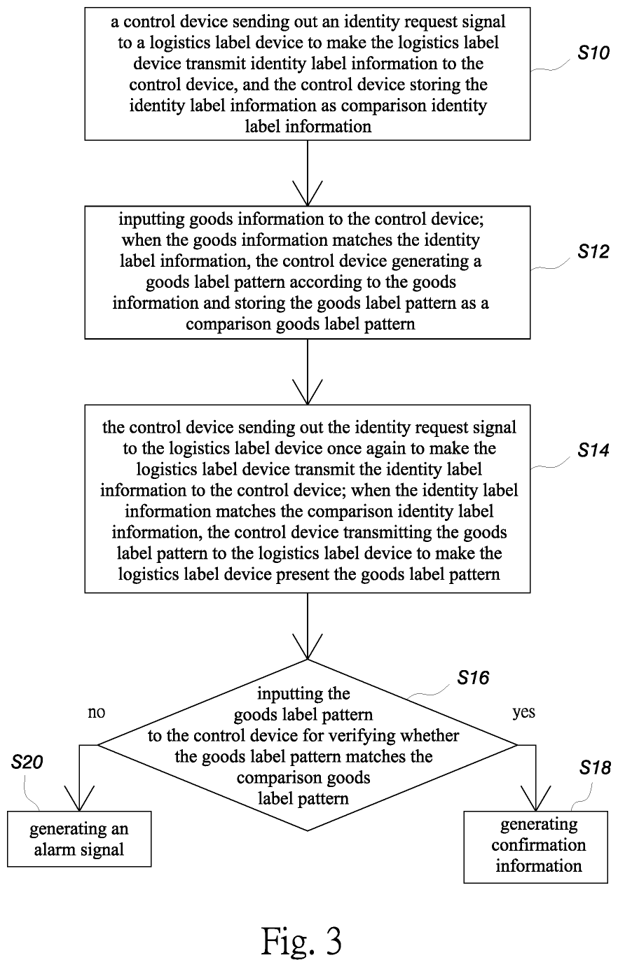

The architecture of the system of the present invention has been described above; the operation and application of the system of the present invention will be introduced below. The method described below can perform double verifications of whether the goods label pattern presented on the electronic label is correctly displayed on the corresponding electronic label, whereby to raise the accuracy of allocating goods into logistics boxes. Refer to Figs.1-3. Firstly, in a step S10, the logistics personnel operates the control device 20 to make the processing unit 20 control the transceiver unit 22 to send out an identity request to the electronic label 12 of the logistics label device 10; the electronic label 12 of the logistics label device 10 transmits the identity label information to the transceiver unit 22, and the processing unit 25 receives the identity label information and stores the identity label information in the database 24 to function as an identity comparison label information; in addition to the abovementioned actions, after the logistics label device 10 transmits the identity label information to the database 24 of the control device 20 for storage, the processing unit 25 of the control device 20 demands the transceiver unit 22 to send a picture-elimination signal to the logistics label device 10 to make the logistics label device 10 eliminate the picture of the display 14.

Next, the process proceeds to a step S12. In the step S12, the input unit 26 captures the image of the goods label 30 on the goods 3; the input unit 26 can immediately generate goods information after capturing the image of the goods label 30 and then inputs the goods information to the processing unit 25; the processing unit 25 accesses the goods identity corresponding table to compare the goods information with the identity label information stored beforehand to determine whether the goods information matches the identity label information in the corresponding table; if the goods information input currently matches the identity label information, the processing unit 25 generates a goods label pattern according to the goods information and stores the goods label pattern in the database 24 to function as a goods comparison label pattern, wherein the goods label pattern may be a bar code, such as a 1-dimensional bar code or a 2-dimensional bar code (Quick Response code (QR code)). If the goods information acquired currently does not match the identity label information stored in the corresponding table, the processing unit 25 generates an alarm signal to control the display unit 28 to present an alert in sounds or images.

After the goods comparison label pattern is generated, the process proceeds to a step S14. In the step S14, the processing unit 25 of the control device 20 once again controls the transceiver unit 22 to send out an identity request to the electronic label 12 of the logistics label device 10 to make the electronic device 12 to once again transmit an identity label information to the transceiver unit 22; next, the processing unit 25 once again receives the identity label information through the transceiver unit 22 and performs comparison to determine whether the identity label information received currently matches the identity comparison label information. If the identity label information does not match the identity comparison label information, the processing unit 25 generates an alarm signal to control the display unit 28 to present an alert in sounds or images. If the identity label information matches the identity comparison label information, the processing unit 25 controls the transceiver unit 22 to transmit the goods label pattern to the display 14 of the logistics label device 10 to make the display 14 present the goods label pattern. In one embodiment, the display 14 is an electronic paper, and the electronic paper does not need batteries. The electronic paper can change the presented image according to the received NFC signal, which is sent out by the transceiver unit 22 and carries the goods label pattern.

The step S14 can perform double verifications to effectively guarantee that the goods label pattern generated by the processing unit 25 can be transmitted to the correct logistic label device 10, whereby to prevent the logistics personnel from scanning a different logistics label device 10 in the next time and transmitting the goods label pattern to an incorrect logistics label device 10. Therefore, the present invention can increase the accuracy of logistics operations.

Then, the process proceeds to a step S16. In step S16, the logistics personnel operates the control device 20 once again to control the input unit 26 to take a picture of the goods label pattern presented on the display 14 of the logistics label device 10 and inputs the goods label pattern to the processing unit 25. Next, the processing unit 25 determines whether the goods label pattern input currently matches the goods comparison label pattern to verify once again whether the goods label pattern is correct and whether the goods label pattern is input correctly. If yes, the processing unit 25 determines that the goods label pattern matches the goods comparison label pattern, and the process proceeds to a step S18. In the step S18, the processing unit 25 generates a confirmation signal to control the display unit 28 to present a confirmation-reminding signal to remind the logistics personnel that the goods information is correct and the goods may be sent out. If no, the goods label pattern does not match the goods comparison label pattern, and the process proceeds to a step S20. In the step S20, the processing unit 25 generates an alarm signal and makes the display unit 28 present an alert. In some embodiments, the alert is presented in sounds or images to remind the logistics personnel that there is an error and that he should check the information once again. The step S16 may be used to perform double verifications to determine whether the goods label pattern presented on the display 14 of the logistics label device 10 is correct and thus can increase the accuracy of the logistics operations.

In conclusion, the present invention can perform double verifications to determine whether the goods label pattern is presented on the corresponding electronic label, whereby to raise the accuracy of allocating goods to logistics boxes, decrease the errors of logistics operations, and increase the efficiency of logistics systems. Besides, the present invention can entirely electronically control the logistics system, which not only can promote the efficiency of logistics systems but also can lower the cost of logistics transportation.

It should be understood: the embodiments described above are only to exemplify the present invention but not to limit the scope of the present invention. Any equivalent modification or variation made according to the spirit or characteristic of the present invention is to be included by the scope of the present invention.

What is claimed is:

1. A smart logistics label system, applicable to a plurality of logistics boxes, and comprising
at least one logistics label device, installed on said logistics boxes, including an electronic label and a display, wherein identity label information is stored in said electronic label; and
a control device, in signal communication with said logistics label device, and including
a transceiver unit, sending out an identity request signal to said electronic label to make said electronic label transmit said identity label information to said transceiver unit;
a database, storing a goods identity corresponding table;
a processing unit, connected with said transceiver unit and said database, receiving said identity label information and storing said identity label information to said database to function as identity comparison label information; and
an input unit, connected with said processing unit, and inputting goods information to said processing unit,
wherein said processing unit accesses said goods identity corresponding table and performs comparison according to said goods identity corresponding table;
wherein when said goods information matches said identity label information, said processing unit generates a goods label pattern according to goods information and stores said goods label pattern into said database to function as a goods comparison label pattern;
wherein said processing unit receives said identity label information through said transceiver unit once again; when said identity label information matches said identity comparison label information, said processing unit controls said transceiver unit to transmit said goods label pattern to a display unit;
wherein said input unit scans said goods label pattern presented on said display unit and transmits said goods label pattern to said processing unit; when said processing unit determines that said goods label pattern matches said goods comparison label pattern, said processing unit generates a confirmation-reminding signal.

2. The smart logistics label system according to claim 1, wherein said display unit is connected with said processing unit to present said confirmation-reminding signal; and when said processing unit determines that said goods label pattern does not match said goods comparison label pattern, said processing unit generates an alarm signal to said display unit to make said display unit emit an alert according to said alarm signal.

3. The smart logistics label system according to claim 1, wherein said input unit is a camera.

4. The smart logistics label system according to claim 1, wherein said goods identity corresponding table includes a plurality of pieces of said goods information and a plurality of pieces of said identity label information, each piece of said goods information is corresponding to a specified piece of said identity label information.

5. The smart logistics label system according to claim 1, wherein said electronic label is a Radio Frequency IDentification (RFID) electronic label.

6. The smart logistics label system according to claim 1, wherein said display is an electronic paper.

7. The smart logistics label system according to claim 1, wherein said transceiver unit is a Near-Field Communication (NFC) transceiver unit.

8. The smart logistics label system according to claim 1, wherein said goods label pattern is a bar code.

9. The smart logistics label system according to claim 1, wherein said processing unit can further control said transceiver unit to send out a picture-elimination signal to said display of said logistics label device for eliminating pictures of said display.

10. A method of using a smart logistics label system, comprising steps:
a control device sending out an identity request signal to a logistics label device to make said logistics label device transmit identity label information to said control device, wherein said control device stores said identity label information as identity comparison label information;
inputting goods information to said control device; when said goods information matches said identity label information, said control device generating a goods label pattern according to said goods information and storing said goods label pattern as a goods comparison label pattern;
said control device sending out said identity request signal to said logistics label device once again to make said logistics label device transmit said identity label information to said control device;
when said identity label information matches said identity comparison label information, said control device transmitting said goods label pattern to said logistics label device to make said logistics label device present said goods label pattern; and
inputting said goods label pattern to said control device; said control device verifying whether said goods label pattern matches said goods comparison label pattern;
if said goods label pattern matches said goods comparison label pattern, generating a confirmation-reminding signal; and
if said goods label pattern does not match said goods comparison label pattern, generating an alarm signal.

11. The method of using a smart logistics label system according to claim 10 further comprising a step: said control device sending out a picture-elimination signal to said logistics label device for eliminating pictures presented on said display of said logistics label device after said control device sends out said identity request signal to said logistics label device to make said logistics label device transmit said identity label information to said control device.

12. The method of using a smart logistics label system according to claim 10, wherein in said step of determining if said goods information matches said identity label information, said control device compares said goods information with said identity label information according to a goods identity corresponding table; said goods identity corresponding table includes a plurality of pieces of said goods information and a plurality of pieces of said identity label information, each piece of said goods information is corresponding to a specified piece of said identity label information.

13. The method of using a smart logistics label system according to claim 10, wherein said goods label pattern is a bar code.
